(19) United States
(12) Patent Application Publication
(10) Pub. No.: US 2018/0040267 A1
(43) Pub. Date: Feb. 8, 2018

(54) DISPLAY APPARATUS AND DRIVING CIRCUIT THEREOF

(71) Applicant: Raydium Semiconductor Corporation, Hsinchu (TW)

(72) Inventors: Chih Chuan HUANG, Zhubei City (TW); Zhen-Yu LI, Kaohsiung City (TW)

(21) Appl. No.: 15/666,849

(22) Filed: Aug. 2, 2017

Related U.S. Application Data
(60) Provisional application No. 62/370,759, filed on Aug. 4, 2016.
(60) Provisional application No. 62/459,663, filed on Feb. 16, 2017.

(51) Int. Cl. G09G 3/00

(52) U.S. Cl. CPC G09G 3/006; G09G 2330/06; G09G 2330/12; G09G 2310/08; G09G 2310/0297

(57) ABSTRACT

A display apparatus and a driving circuit thereof are disclosed. The display apparatus includes a display panel, a timing controller and a plurality of driving circuits. The timing controller is used to generate a plurality of independent timing control signals respectively. The plurality of driving circuits is coupled between the timing controller and the display panel respectively. The plurality of driving circuits receives the plurality of independent timing control signals respectively and generates a plurality of independent clock signals respectively. The plurality of driving circuits randomly performs different modulations on the plurality of independent clock signals respectively to make different changes on phases of the plurality of clock signals with time. Therefore, the phases of the plurality of clock signals generated by the plurality of driving circuits will be different.

### BACKGROUND OF THE INVENTION

### 1. Field of the Invention

The invention relates to a display; in particular, to a display apparatus and a driving circuit thereof

### 2. Description of the Prior Art

In general, when the display apparatus is under the electromagnetic interference (EMI) test, the display apparatus will be powered on/off for several times to measure the EMI value and determine whether the EMI value is the same every time when the display apparatus is powered on.

For the conventional low-voltage differential signaling (LVDS) system, at the same time when it is powered on, the timing controller (T-CON) in the conventional LVDS system will control all clock signals transmitted to different source driving ICs to ensure that the clock signals generated by different source driving ICs will be approximately the same. Therefore, the EMI value measured every time when the display apparatus is powered on can be approximately the same.

However, in the new P2P signal transmission structure, the control signals transmitted from the timing controller to the source driving ICs are independent, so that each source driving ICs generates corresponding clock signal respectively. Since the signal receiving paths of the source driving ICs disposed on the display panel may be slightly different and there is manufacturing errors existed between the source driving ICs. Therefore, different EMI values may be measured when the display apparatus is powered on/off for several times.

For example, as shown in FIG. 1, if the N clock signals CLK1˜CLKN of the N source driving ICs have the same phase, the energy of EMI signals will be highest. On the contrary, as shown in FIG. 2, if the N clock signals CLK1˜CLKN of the N source driving ICs have different phases, the energy of EMI signals will be lowest.

In practical applications, the spread spectrum clock generator (SSCG) can be used to modulate the frequency to reduce the energy of EMI signals. For example, as shown in FIG. 3, NM is a frequency response curve obtained by conventional circuit and SSCG is a frequency response curve obtained by the spread spectrum clock generator.

However, since the spread spectrum clock generator modulates the frequency in a regular way, it can only spread the signal energy of single source driving IC to reduce the energy of EMI signals, but it still fails to overcome the issue of superimposing the EMI values of different source driving ICs. Thus, as shown in FIG. 4, every time when the display apparatus is powered on/off to perform EMI test, even the spread spectrum clock generator is used to modulate the frequency, different EMI values may be obtained and the yield and operation stability of the display apparatus will become poor.

### SUMMARY OF THE INVENTION

Therefore, the invention provides a display apparatus and a driving circuit thereof to overcome the above-mentioned problems in the prior art.

An embodiment of the invention is a display apparatus. In this embodiment, the display apparatus includes a display panel, a timing controller and a plurality of driving circuits. The timing controller is used to generate a plurality of independent timing control signals respectively. The plurality of driving circuits is coupled between the timing controller and the display panel respectively. The plurality of driving circuits receives the plurality of independent timing control signals respectively and generates a plurality of independent clock signals respectively. The plurality of driving circuits randomly performs different modulations on the plurality of independent clock signals respectively to make different changes on phases of the plurality of clock signals with time. Therefore, the phases of the plurality of clock signals generated by the plurality of driving circuits will be different.

In an embodiment, the plurality of driving circuits includes a first driving circuit and a second driving circuit, the plurality of independent timing control signals includes a first timing control signal and a second timing control signal, the plurality of independent clock signals includes a first clock signal and a second clock signal, the first driving circuit receives the first timing control signal and generates the first clock signal and the second driving circuit receives the second timing control signal and generates the second clock signal.

In an embodiment, the first driving circuit includes a first random phase modulation module and the second driving circuit includes a second random phase modulation module, the first random phase modulation module and the second random phase modulation module randomly perform different modulations on a phase of the first clock signal and a phase of the second clock signal to randomly change the phase of the first clock signal and the phase of the second clock signal with time to make the phase of the first clock signal and the phase of the second clock signal different.

In an embodiment, the first random phase modulation module and the second random phase modulation module randomly select a first candidate clock signal and a second candidate clock signal having different phases as the first clock signal and the second clock signal respectively from a plurality of candidate clock signals in a random phase selecting way.

In an embodiment, the first random phase modulation module and the second random phase modulation module randomly reset the phase of the first clock signal and the phase of the second clock signal respectively to generate the first clock signal and the second clock signal having different phases respectively.

In an embodiment, the display apparatus further includes a measuring module. The measuring module is coupled to the plurality of driving circuits and used for measuring a total energy and an electromagnetic interference value of the plurality of clock signals generated by the plurality of driving circuits.

In an embodiment, the plurality of clock signals generated by the plurality of driving circuits has randomly distributed different phases respectively, the total energy of the plurality of clock signals measured by the measuring module at different times is approximately equal and the electromagnetic interference value of the plurality of clock signals measured by the measuring module at different times is lowest.

Another embodiment of the invention is a driving circuit. In this embodiment, the driving circuit is applied to a display apparatus and coupled to a display panel of the display apparatus. The driving circuit includes a clock generation module, a random phase selection module and a source driving module. The clock generation module is used for receiving a first timing control signal and generating a plurality of first candidate clock signals having different phases. The random phase selection module is coupled to the clock generation module and used for randomly selecting different first candidate clock signals as a first clock signal at different times from the plurality of first candidate clock signals to randomly change a phase of the first clock signal with time. The source driving module is coupled between the random phase selection module and the display panel and used for receiving the first clock signal and outputting a first source driving signal to the display panel.

Another embodiment of the invention is a driving circuit. In this embodiment, the driving circuit is applied to a display apparatus and coupled to a display panel of the display apparatus. The driving circuit includes a clock generation module, a random phase resetting module and a source driving module. The clock generation module is used for receiving a first timing control signal and generating a first clock signal. The random phase resetting module is coupled to the clock generation module and used for receiving the first clock signal and randomly resetting the first clock signal at different times to randomly change a phase of the first clock signal with time. The source driving module is coupled between the random phase resetting module and the display panel and used for receiving the first clock signal and outputting a first source driving signal to the display panel.

Compared to the prior arts, the display apparatus of the invention performs random modulation on the phase of the clock signal in each source driver respectively to change different phases in a fixed time or a random time. Since the modulation time of each source driver will be randomly distributed and different, the phase of the clock signal of each source driver will be spread for a long time to reduce the energy of EMI signals to lowest and the same EMI value may be obtained every time when the display apparatus is powered on/off to perform EMI test; therefore, the yield and operation stability of the display apparatus of the invention can be effectively improved.

The advantage and spirit of the invention may be understood by the following detailed descriptions together with the appended drawings.

### BRIEF DESCRIPTION OF THE APPENDED DRAWINGS

FIG. 1 illustrates a timing diagram of the plurality of source driving ICs having clock signals with the same phase.

FIG. 2 illustrates a timing diagram of the plurality of source driving ICs having clock signals with different phases.

FIG. 3 illustrates the frequency response curves obtained by the conventional circuit and the spread spectrum clock generator respectively.

FIG. 4 illustrates that every time when the display apparatus is powered on/off to perform EMI test, different EMI values may be obtained even the spread spectrum clock generator is used to modulate the frequency.

FIG. 5 illustrates a schematic diagram of the display apparatus in a preferred embodiment of the invention.

FIG. 6 illustrates functional block diagrams of the first driving circuit and the second driving circuit in an embodiment.

FIG. 7A illustrates an embodiment of the first random phase selection module in the first driving circuit.

FIG. 7B illustrates an embodiment of the second random phase selection module in the second driving circuit.

FIG. 8 illustrates functional block diagrams of the first driving circuit and the second driving circuit in another embodiment.

FIG. 9A illustrates an embodiment of the first random phase resetting module in the first driving circuit.

FIG. 9B illustrates an embodiment of the second random phase resetting module in the second driving circuit.

FIG. 10A illustrates an embodiment of the first random phase resetting unit in the first random phase resetting module.

FIG. 10B illustrates an embodiment of the second random phase resetting unit in the second random phase resetting module.

FIG. 11A illustrates a timing diagram of the effect obtained by the random phase resetting circuit disposed in the divider circuit.

FIG. 11B illustrates a timing diagram of the effect obtained by the random phase resetting circuit disposed in the voltage control oscillator (VCO) or the serial to parallel circuit.

FIG. 12 illustrates a schematic diagram of the frequency distribution of the oscillator for controlling the phase resetting time.

FIG. 13 illustrates that every time when the display apparatus is powered on/off to perform EMI test, stable EMI values can be obtained by the random phase modulation of the invention.

FIG. 14 illustrates timing diagrams of the original clock signal CLK0 without random phase modulation and the N random phase modulated clock signals CLK1˜CLKN of the N source driving circuits.

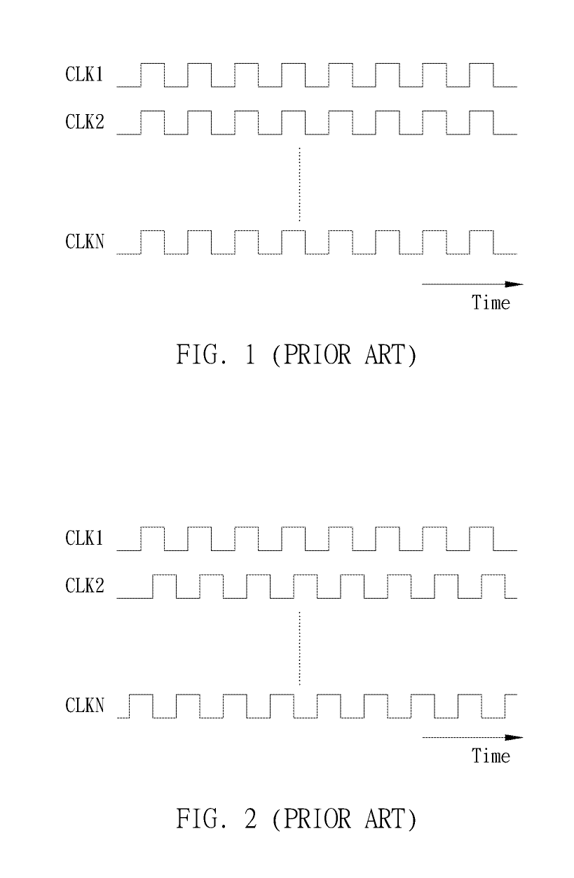

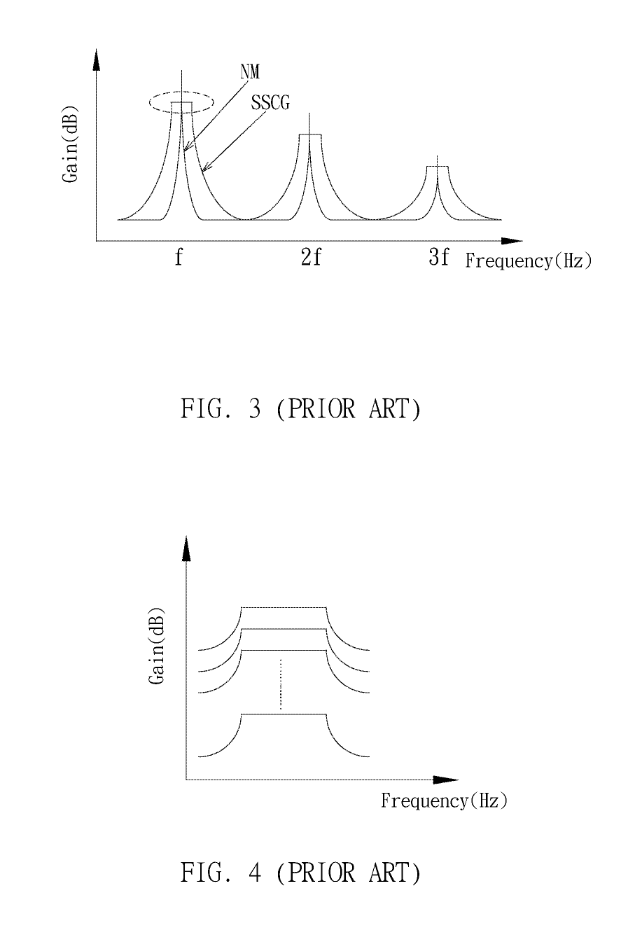

### DETAILED DESCRIPTION OF THE INVENTION

A preferred embodiment of the invention is a display apparatus. Please refer to

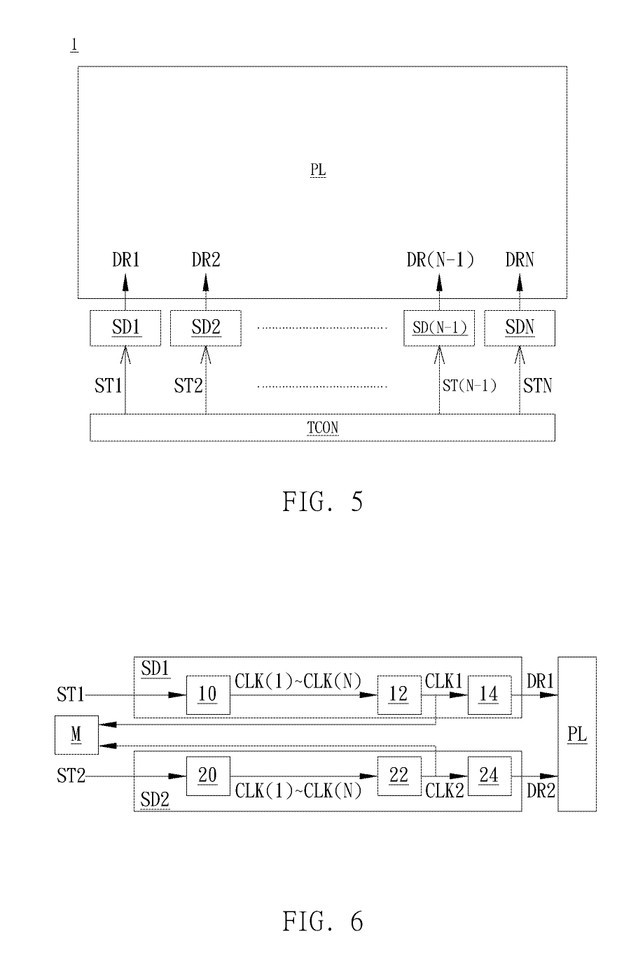

FIG. 5. In this embodiment, the display apparatus 1 can include a display panel PL, a timing controller TCON and N driving circuits SD1˜SDN. The N driving circuits SD1˜SDN are coupled between the timing controller TCON and the display panel PL respectively, wherein the N driving circuits SD1˜SDN are all source drivers, and N is a positive integer larger than or equal to 2.

The timing controller TCON is used to generate N independent timing control signals ST1˜STN respectively and output the N independent timing control signals ST1˜STN to the N driving circuits SD1˜SDN respectively. The N driving circuits SD1˜SDN receive the N independent timing control signals ST1˜STN respectively and generate N independent source driving signals DR1˜DRN to the display panel PL according to the N independent timing control signals ST1˜STN respectively.

Next, please refer to FIG .6. FIG. 6 illustrates functional block diagrams of the first driving circuit SD1 and the second driving circuit SD2 of the N driving circuits SD1˜SDN in an embodiment, but not limited to this.

As shown in FIG. 6, the first driving circuit SD1 includes a first clock generation module 10, a first random phase selection module 12 and a first source driving module 14. The first clock generation module 10 is coupled to the first random phase selection module 12. The first random phase selection module 12 is coupled to the first source driving module 14. The first source driving module 14 is coupled to the display panel PL.

The first clock generation module 10 is used to receive the first timing control signal ST1 from the timing controller TCON and generate N candidate clock signals CLK(1)˜CLK(N) having different phases to the first random phase selection module 12 respectively according to the first timing control signal ST1.

Then, the first random phase selection module 12 randomly selects different candidate clock signals from the N candidate clock signals CLK(1)˜CLK(N) as a first clock signal CLK1 at different times respectively and then outputs the first clock signal CLK1 to the first source driving module 14; therefore, the phase of the first clock signal CLK1 outputted from the first random phase selection module 12 to the first source driving module 14 will be randomly changed with time. When the first source driving module 14 receives the first clock signal CLK1 having phase randomly changed with time, the first source driving module 14 will generate the first source driving signal DR1 according to the first clock signal CLK1 and then output the first source driving signal DR1 to the display panel PL.

For example, at the first time, the first random phase selection module 12 can randomly select the candidate clock signal CLK(1) from the N candidate clock signals CLK(1)˜CLK(N) as the first clock signal CLK1 and output the first clock signal CLK1 to the first source driving module 14; at the second time, the first random phase selection module 12 can randomly select another candidate clock signal CLK(5) from the N candidate clock signals CLK(1)˜CLK(N) as the first clock signal CLK1 and output the first clock signal CLK1 to the first source driving module 14, and so on. Since the N candidate clock signals CLK(1)˜CLK(N) have different phases respectively, the first clock signal CLK1 outputted from the first random phase selection module 12 to the first source driving module 14 will also have different phases at different times respectively.

Similarly, the second driving circuit SD2 includes a second clock generation module 20, a second random phase selection module 22 and a second source driving module 24. The second clock generation module 20 is coupled to the second random phase selection module 22. The second random phase selection module 22 is coupled to the second source driving module 24. The second source driving module 24 is coupled to the display panel PL.

The second clock generation module 20 is used to receive the second timing control signal ST2 from the timing controller TCON and generate N candidate clock signals CLK(1)˜CLK(N) having different phases to the second random phase selection module 22 respectively according to the second timing control signal ST2.

Then, the second random phase selection module 22 randomly selects different candidate clock signals from the N candidate clock signals CLK(1)˜CLK(N) as a second clock signal CLK2 at different times respectively and then outputs the second clock signal CLK2 to the second source driving module 24; therefore, the phase of the second clock signal CLK2 outputted from the second random phase selection module 22 to the second source driving module 24 will be randomly changed with time. When the second source driving module 24 receives the second clock signal CLK2 having phase randomly changed with time, the second source driving module 24 will generate the second source driving signal DR2 according to the second clock signal CLK2 and then output the second source driving signal DR2 to the display panel PL.

For example, at the first time, the second random phase selection module 22 can randomly select the candidate clock signal CLK(3) from the N candidate clock signals CLK(1)˜CLK(N) as the second clock signal CLK2 and output the second clock signal CLK2 to the second source driving module 24; at the second time, the second random phase selection module 22 can randomly select another candidate clock signal CLK(8) from the N candidate clock signals CLK(1)˜CLK(N) as the second clock signal CLK2 and output the second clock signal CLK2 to the second source driving module 24, and so on. Since the N candidate clock signals CLK(1)˜CLK(N) have different phases respectively, the second clock signal CLK2 outputted from the second random phase selection module 22 to the second source driving module 24 will also have different phases at different times respectively.

From above, it can be found that the phases of the first clock signal CLK1 and the second clock signal CLK2 outputted from the first random phase selection module 12 and the second random phase selection module 22 are randomly changed with time; that is to say, the phase of the first clock signal CLK1 and the phase of the second clock signal CLK2 generated by the first driving circuit SD1 and the second driving circuit SD2 respectively will be different due to their different changes with time.

For example, at the first time, the first random phase selection module 12 and the second random phase selection module 22 can randomly select the candidate clock signals CLK(3) and CLK(7) from the N candidate clock signals CLK(1)˜CLK(N) as the first clock signal CLK1 and the second clock signal CLK2 respectively and then output the first clock signal CLK1 and the second clock signal CLK2 to the first source driving module 14 and the second source driving module 24 respectively. At the second time, the first random phase selection module 12 and the second random phase selection module 22 can randomly select the candidate clock signals CLK(5) and CLK(2) from the N candidate clock signals CLK(1)˜CLK(N) as the first clock signal CLK1 and the second clock signal CLK2 respectively and then output the first clock signal CLK1 and the second clock signal CLK2 to the first source driving module 14 and the second source driving module 24 respectively, and so on.

In addition, the display apparatus 1 further includes a measuring module M. The measuring module M is coupled between the first random phase selection module 12 and the first source driving module 14 of the first driving circuit SD1 and between the second random phase selection module 22 and the second source driving module 24 of the second driving circuit SD2. The measuring module M is used for measuring a total energy and an electromagnetic interference value of the first clock signal CLK1 of the first driving circuit SD1 and the second clock signal CLK2 of the second driving circuit SD2.

Since the phase of the first clock signal CLK1 of the first driving circuit SD1 and the phase of the second clock signal CLK2 of the second driving circuit SD2 are different, the measuring module M will measure approximately equal total energy and lowest electromagnetic interference value of the first clock signal CLK1 of the first driving circuit SD1 and the second clock signal CLK2 of the second driving circuit SD2 at different times.

It should be noticed that, for N driving circuits SD1˜SDN, the measuring module M can measure the total energy and the electromagnetic interference value of the N clock signals CLK1˜CLKN generated by the N driving circuits SD1˜SDN respectively.

Above all, since the display apparatus 1 uses random phase selection to provide different changes on the phases of the N clock signals CLK1˜CLKN generated by the N driving circuits SD1˜SDN with time to make them different. For a long time, since the phases of the N clock signals CLK1˜CLKN generated by the N driving circuits SD1˜SDN will be randomly distributed, every time when the display apparatus is powered on/off to perform EMI test, the energy of EMI signals can be reduced to lowest and the measuring module M can obtain approximately the same and stable EMI value to effectively overcome the problems occurred in the prior arts.

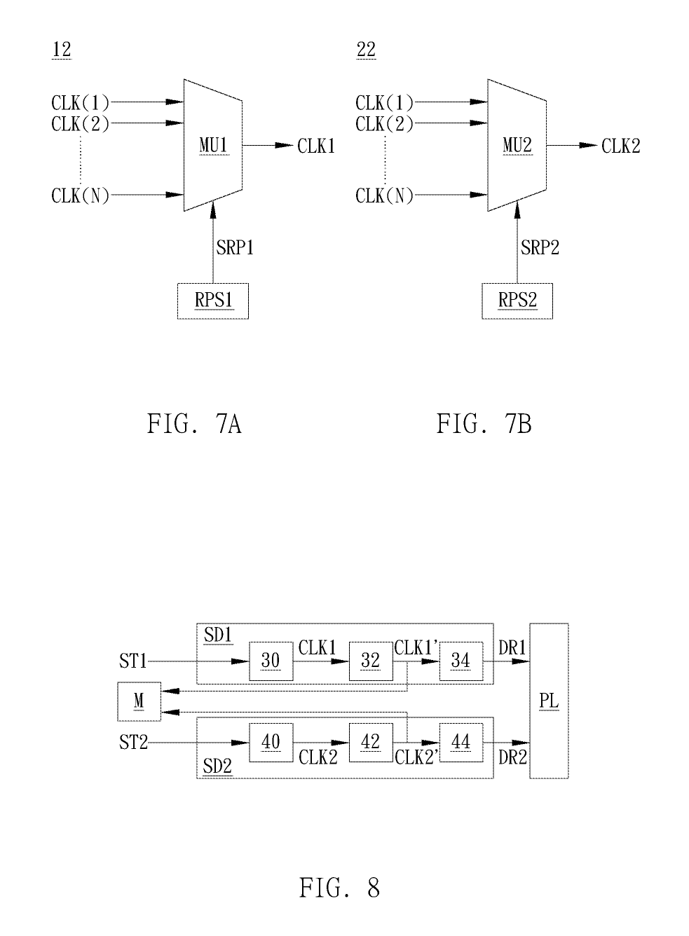

Then, please refer to FIG. 7A and FIG. 7B. FIG. 7A illustrates an embodiment of the first random phase selection module 12 in the first driving circuit SD1. FIG. 7B illustrates an embodiment of the second random phase selection module 22 in the second driving circuit SD2.

As shown in FIG. 7A, the first random phase selection module 12 in the first driving circuit SD1 can include a first random phase selection unit RPS1 and a first multiplexing unit MU1. The first multiplexing unit MU1 is coupled to the first clock generation module 10, the first random phase selection unit RPS1 and the first source driving module 14 respectively. The first random phase selection unit RPS1 is used to generate a first random phase selection signal SRP1 to the first multiplexing unit MU1. After the first multiplexing unit MU1 receives the N candidate clock signals CLK(1)˜CLK(N) from the first clock generation module 10 and the first random phase selection signal SRP1 from the first random phase selection unit RPS1, the first multiplexing unit MU1 will randomly select different candidate clock signals having different phases as the first clock signal CLK1 at different times from the N candidate clock signals CLK(1)˜CLK(N), so that the phase of the first clock signal CLK1 will be randomly changed with time.

As shown in FIG. 7B, the second random phase selection module 22 in the second driving circuit SD2 can include a second random phase selection unit RPS2 and a second multiplexing unit MU2. The second multiplexing unit MU2 is coupled to the second clock generation module 20, the second random phase selection unit RPS2 and the second source driving module 24 respectively. The second random phase selection unit RPS2 is used to generate a second random phase selection signal

SRP2 to the second multiplexing unit MU2. After the second multiplexing unit MU2 receives the N candidate clock signals CLK(1)˜CLK(N) from the second clock generation module 20 and the second random phase selection signal SRP2 from the second random phase selection unit RPS2, the second multiplexing unit MU2 will randomly select different candidate clock signals having different phases as the second clock signal CLK2 at different times from the N candidate clock signals CLK(1)˜CLK(N), so that the phase of the second clock signal CLK2 will be randomly changed with time.

Then, please refer to FIG. 8. FIG. 8 illustrates functional block diagrams of the first driving circuit SD1 and the second driving circuit SD2 in another embodiment, but not limited to this.

As shown in FIG. 8, the first driving circuit SD1 includes a first clock generation module 30, a first random phase resetting module 32 and a first source driving module 34. The first clock generation module 30 is coupled to the first random phase resetting module 32. The first random phase resetting module 32 is coupled to the first source driving module 34. The first source driving module 34 is coupled to the display panel PL.

The first clock generation module 30 is used to receive the first timing control signal ST1 from the timing controller TCON and generate a first clock signal CLK1 to the first random phase resetting module 32 according to the first timing control signal ST1. When the first random phase resetting module 32 receives the first clock signal CLK1, the first random phase resetting module 32 will randomly reset the first clock signal CLK1 at different times and then output the reset first clock signal CLK1′ to the first source driving module 34, and the phase of the reset first clock signal CLK1′ reset by the first random phase resetting module 32 will be randomly changed with time. When the first source driving module 34 receives the reset first clock signal CLK1′, the first source driving module 34 will generate the first source driving signal DR1 according to the reset first clock signal CLK1′ and then output the first source driving signal DR1 to the display panel PL.

Similarly, the second driving circuit SD2 includes a second clock generation module 40, a second random phase resetting module 42 and a second source driving module 44. The second clock generation module 40 is coupled to the second random phase resetting module 42. The second random phase resetting module 42 is coupled to the second source driving module 44. The second source driving module 44 is coupled to the display panel PL.

The second clock generation module 40 is used to receive the second timing control signal ST2 from the timing controller TCON and generate a second clock signal CLK2 to the second random phase resetting module 42 according to the second timing control signal ST2. When the second random phase resetting module 42 receives the second clock signal CLK2, the second random phase resetting module 42 will randomly reset the second clock signal CLK2 at different times and then output the reset second clock signal CLK2′ to the second source driving module 44, and the phase of the reset second clock signal CLK2′ reset by the second random phase resetting module 42 will be randomly changed with time. When the second source driving module 44 receives the reset second clock signal CLK2′, the second source driving module 44 will generate the second source driving signal DR2 according to the reset second clock signal CLK2′ and then output the second source driving signal DR2 to the display panel PL.

From above, it can be found that the first random phase resetting module 32 of the first driving circuit SD1 and the second random phase resetting module 42 of the second driving circuit SD2 will randomly reset the first clock signal CLK1 and the second clock signal CLK2 at different times respectively to generate the reset first clock signal CLK1′ and the reset second clock signal CLK2′ respectively. Therefore, as to the N driving circuits SD1˜SDN, the N driving circuits SD1˜SDN will randomly reset the first clock signal CLK1˜the N-th clock signal CLKN at different times to generate the reset first clock signal CLK1′˜the reset N-th clock signal CLKN′ respectively.

In addition, the display apparatus 1 further includes a measuring module M. The measuring module M is coupled between the first random phase resetting module 32 and the first source driving module 34 of the first driving circuit SD1 and between the second random phase resetting module 42 and the second source driving module 44 of the second driving circuit SD2. The measuring module M is used for measuring a total energy and an electromagnetic interference value of the reset first clock signal CLK1′ of the first driving circuit SD1 and the reset second clock signal CLK2′ of the second driving circuit SD2.

Since the phase of the reset first clock signal CLK1′ of the first driving circuit SD1 and the phase of the reset second clock signal CLK2′ of the second driving circuit SD2 are different, the measuring module M will measure approximately equal total energy and lowest electromagnetic interference value of the reset first clock signal CLK1′ of the first driving circuit SD1 and the reset second clock signal CLK2′ of the second driving circuit SD2 at different times.

It should be noticed that, for N driving circuits SD1˜SDN, the measuring module M can measure the total energy and the electromagnetic interference value of the N reset clock signals CLK1′˜CLKN′ generated by the N driving circuits SD1˜SDN respectively.

Above all, since the display apparatus 1 uses random phase resetting to provide different changes on the phases of the N reset clock signals CLK1′˜CLKN′ generated by the N driving circuits SD1˜SDN with time to make them different. For a long time, since the phases of the N reset clock signals CLK1′˜CLKN′ generated by the N driving circuits SD1˜SDN will be randomly distributed, every time when the display apparatus is powered on/off to perform EMI test, the energy of EMI signals can be reduced to lowest and the measuring module M can obtain approximately the same and stable EMI value to effectively overcome the problems occurred in the prior arts.

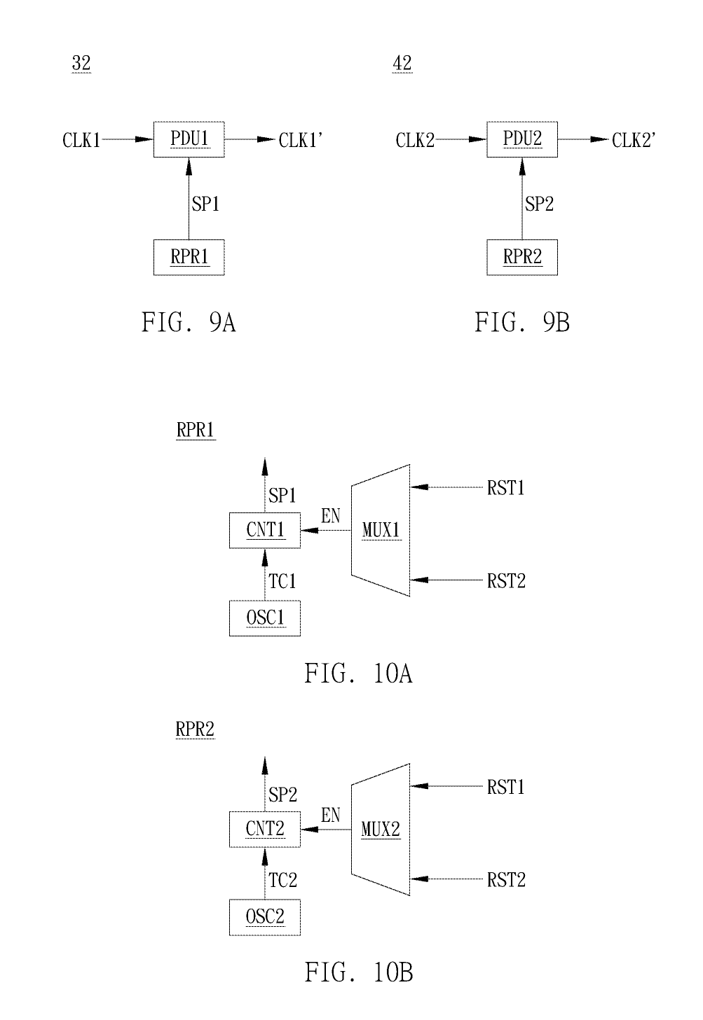

Then, please refer to FIG. 9A and FIG. 9B. FIG. 9A illustrates an embodiment of the first random phase resetting module 32 in the first driving circuit SD1. FIG. 9B illustrates an embodiment of the second random phase resetting module 42 in the second driving circuit SD2, but not limited to this.

As shown in FIG. 9A, the first random phase resetting module 32 in the first driving circuit SD1 includes a first random phase resetting unit RPR1 and a first phase determining unit PDU1. The first phase determining unit PDU1 is coupled to the first clock generation module 30, the first random phase resetting unit RPR1 and the first source driving module 34.

The first random phase resetting unit RPR1 is used for generating a first random phase resetting signal SP1. The first phase determining unit PDU1 is used for receiving the first clock signal CLK1 from the first clock generation module 30 and the first random phase resetting signal SP1 from the first random phase resetting unit RPR1 and randomly resetting the first clock signal CLK1 at different times according to the first random phase resetting signal SP1 to randomly change the phase of the first clock signal CLK1 with time.

Similarly, as shown in FIG. 9B, the second random phase resetting module 42 in the second driving circuit SD2 includes a second random phase resetting unit RPR2 and a second phase determining unit PDU2. The second phase determining unit PDU2 is coupled to the second clock generation module 40, the second random phase resetting unit RPR2 and the second source driving module 44.

The second random phase resetting unit RPR2 is used for generating a second random phase resetting signal SP2. The second phase determining unit PDU2 is used for receiving the second clock signal CLK2 from the second clock generation module 40 and the second random phase resetting signal SP2 from the second random phase resetting unit RPR2 and randomly resetting the second clock signal CLK2 at different times according to the second random phase resetting signal SP2 to randomly change the phase of the second clock signal CLK2 with time.

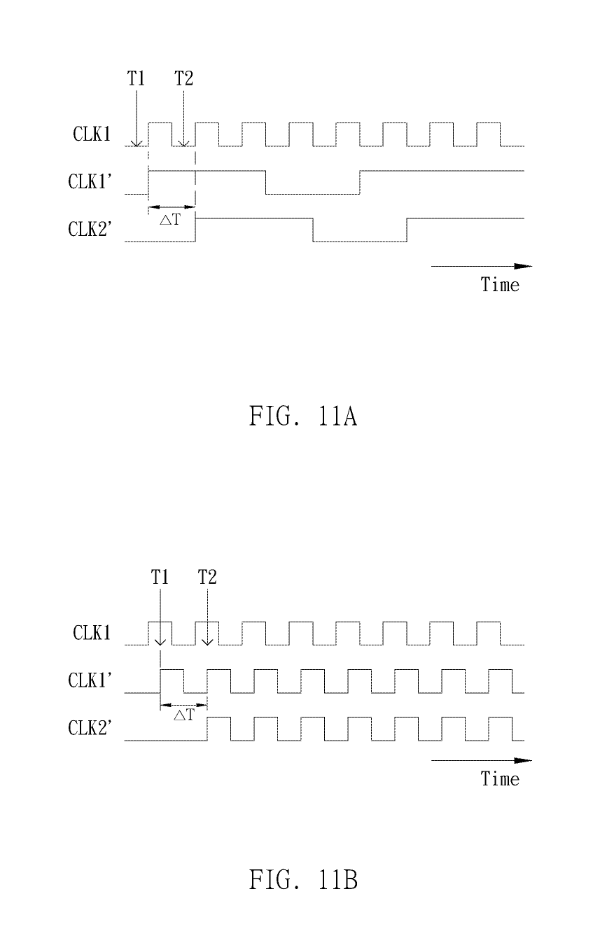

In addition, please refer to FIG. 10A and FIG. 10B. FIG. 10A illustrates an embodiment of the first random phase resetting unit RPR1 in the first random phase resetting module 32. FIG. 10B illustrates an embodiment of the second random phase resetting unit RPR2 in the second random phase resetting module 42, but not limited to this.

As shown in FIG. 10A, the first random phase resetting unit RPR1 in the first random phase resetting module 32 includes a first oscillator OSC1, a first multiplexer MUX1 and a first counter CNT1. The first oscillator OSC1 is coupled to the first counter CNT1. The first multiplexer MUX1 is coupled to the first counter CNT1. The first counter CNT1 is coupled to the first phase determining unit PDU1.

The first multiplexer MUX1 can receive a first reset signal RST1 and a second reset signal RST2 respectively and generate an enable signal EN to the first counter CNT1 according to the first reset signal RST1 and the second reset signal RST2. When the first counter CNT1 receives the enable signal EN, the first oscillator OSC1 will generate a first reset time control signal TC1 to control the first counter CNT1 to start to count time and output the first random phase resetting signal SP1 to the first phase determining unit PDU1. In fact, the first reset signal RST1 and the second reset signal RST2 can be a frame resetting signal and a line resetting signal respectively, but not limited to this.

Similarly, as shown in FIG. 10B, the second random phase resetting unit RPR2 in the second random phase resetting module 42 includes a second oscillator OSC2, a second multiplexer MUX2 and a second counter CNT2. The second oscillator OSC2 is coupled to the second counter CNT2. The second multiplexer MUX2 is coupled to the second counter CNT2. The second counter CNT2 is coupled to the second phase determining unit PDU2.

The second multiplexer MUX2 can receive a first reset signal RST1 and a second reset signal RST2 respectively and generate an enable signal EN to the second counter CNT2 according to the first reset signal RST1 and the second reset signal RST2. When the second counter CNT2 receives the enable signal EN, the second oscillator OSC2 will generate a second reset time control signal TC2 to control the second counter CNT2 to start to count time and output the second random phase resetting signal SP2 to the second phase determining unit PDU2. In fact, the first reset signal RST1 and the second reset signal RST2 can be a frame resetting signal and a line resetting signal respectively, but not limited to this.

In practical applications, the first phase determining unit PDU1 in the first random phase resetting module 32 and the second phase determining unit PDU2 in the second random phase resetting module 42 can be any circuit having phase switching function, such as the divider circuit, the voltage control oscillator (VCO) circuit or the serial to parallel circuit, without specific limitations.

Please refer to FIG. 11A. In an embodiment, if the first phase determining unit PDU1 in the first random phase resetting module 32 and the second phase determining unit PDU2 in the second random phase resetting module 42 are disposed in the divider circuit, the effect obtained is shown in the timing diagram of FIG. 11A, but not limited to this.

Please refer to FIG. 11B. In another embodiment, if the first phase determining unit PDU1 in the first random phase resetting module 32 and the second phase determining unit PDU2 in the second random phase resetting module 42 are disposed in the voltage control oscillator (VCO) circuit or the serial to parallel circuit, the effect obtained is shown in the timing diagram of FIG. 11B, but not limited to this.

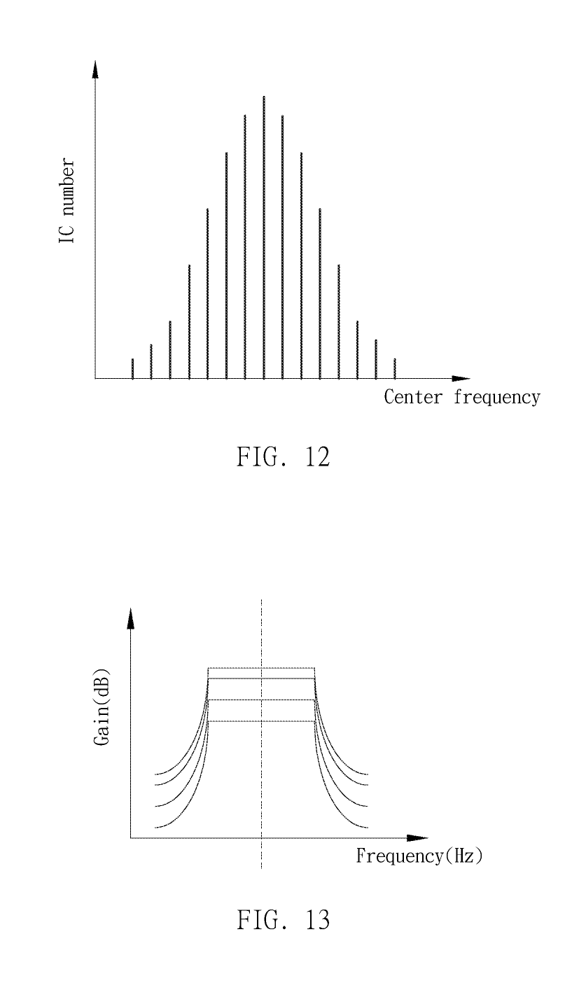

It should be noticed that, as shown in FIG. 12, the oscillating frequency distribution of the first oscillator OSC1 of the first driving circuit SD1 and the second oscillator OSC2 of the second driving circuit SD2 will be the Gaussian distribution. Since there is usually a slight oscillating frequency difference between the first oscillator OSC1 and the second oscillator OSC2, the phase resetting times of the first oscillator OSC1 and the second oscillator OSC2 will be also different. In addition, since the first oscillator OSC1 and the second oscillator OSC2 may also have the clock jitter issue, the phase resetting times of the first driving circuit SD1 and the second driving circuit SD2 will become more random distribution.

Furthermore, since the oscillating frequencies of the first oscillator OSC1 and the second oscillator OSC2 is much slower than the frequencies of the first clock signal CLK1 and the second clock signal CLK2 generated by the first clock generation module 30 and the second clock generation module 40, even there is only slight frequency difference between the first oscillator OSC1 and the second oscillator OSC2, it can still cause an obvious phase shift of the first clock signal CLK1 and the second clock signal CLK2 generated by the first clock generation module 30 and the second clock generation module 40; therefore, the effect of random phase resetting can be effectively achieved to obtain the same EMI value every time when the display apparatus is powered on/off to perform EMI test, as shown in FIG. 13.

It should be noticed that, after comparing FIG. 13 of the invention and FIG. 4 of the prior art, it can be found that although the spread spectrum clock generator (SSCG) is used to modulate the frequency in the prior art, as shown in FIG. 4, every time when the display apparatus is powered on/off to perform EMI test, different EMI values may be obtained and become unstable; on the contrary, the random phase modulation is used in the invention, as shown in FIG. 13, every time when the display apparatus is powered on/off to perform EMI test, approximately the same EMI values can be obtained and the stability of the EMI test can be effectively improved.

In addition, in practical applications, a delaying unit including a resistor and a capacitor can be also used to achieve phase resetting at different default times, so that the charging times/discharging times will have slight differences to achieve random effect similar to the oscillator.

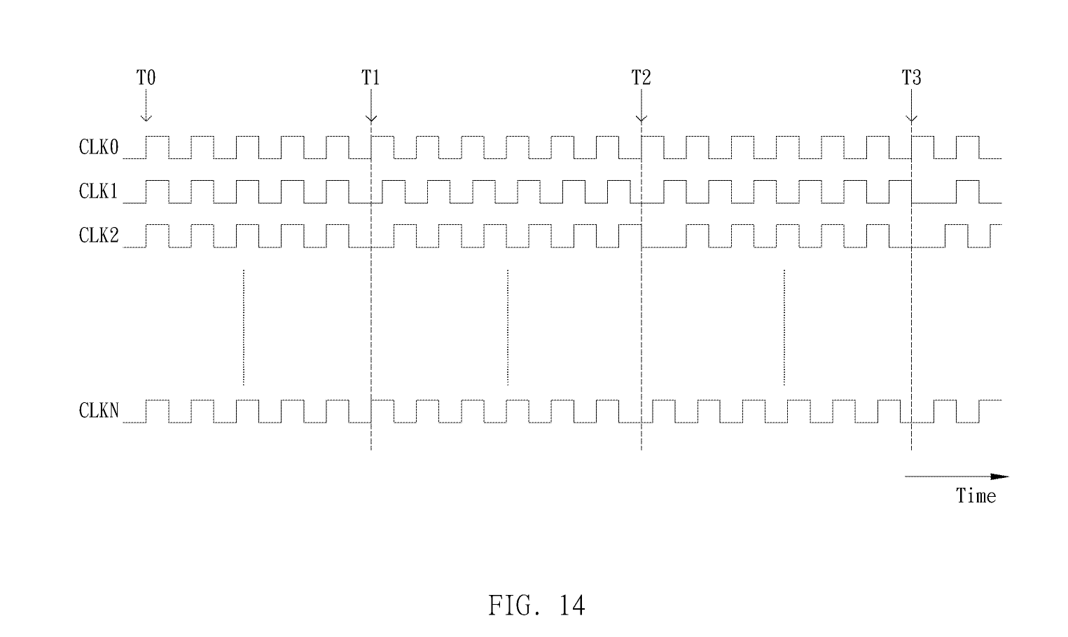

Please refer to FIG. 14. FIG. 14 illustrates timing diagrams of the original clock signal CLK0 without random phase modulation and the N random phase modulated clock signals CLK1˜CLKN of the N source driving circuits.

As shown in FIG. 14, during the period of the staring time T0 to the first phase resetting time T1, the phases of the N clock signals CLK1˜CLKN of the N source driving circuits are the same with the phase of the original clock signal CLK0.

At the first phase resetting time T1, the N source driving circuits start to randomly perform a first phase modulation on the phases of the N clock signals CLK1˜CLKN, so that the phases of the N clock signals CLK1˜CLKN will be changed differently and become different phases.

Similarly, at the second phase resetting time T2, the N source driving circuits start to randomly perform a second phase modulation on the phases of the N clock signals CLK1˜CLKN, so that the phases of the N clock signals CLK1˜CLKN will be changed differently again and become different phases again, and so on for the condition at the third phase resetting time T3.

Compared to the prior arts, the display apparatus of the invention performs random modulation on the phase of the clock signal in each source driver respectively to change different phases in a fixed time or a random time. Since the modulation time of each source driver will be randomly distributed and different, the phase of the clock signal of each source driver will be spread for a long time to reduce the energy of EMI signals to lowest and the same EMI value may be obtained every time when the display apparatus is powered on/off to perform EMI test; therefore, the yield and operation stability of the display apparatus of the invention can be effectively improved.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A display apparatus, comprising:
a display panel;
a timing controller for generating a plurality of independent timing control signals respectively; and
a plurality of driving circuits, coupled between the timing controller and the display panel respectively, for receiving the plurality of independent timing control signals respectively and generating a plurality of independent clock signals respectively;
wherein the plurality of driving circuits randomly performs different modulations on the plurality of independent clock signals respectively to randomly change phases of the plurality of independent clock signals with time to make the phases of the plurality of independent clock signals different.

2. The display apparatus of claim 1, wherein the plurality of driving circuits comprises a first driving circuit and a second driving circuit, the plurality of independent timing control signals comprises a first timing control signal and a second timing control signal, the plurality of independent clock signals comprises a first clock signal and a second clock signal, the first driving circuit receives the first timing control signal and generates the first clock signal and the second driving circuit receives the second timing control signal and generates the second clock signal.

3. The display apparatus of claim 2, wherein the first driving circuit comprises a first random phase modulation module and the second driving circuit comprises a second random phase modulation module, the first random phase modulation module and the second random phase modulation module randomly perform different modulations on a phase of the first clock signal and a phase of the second clock signal to randomly change the phase of the first clock signal and the phase of the second clock signal with time to make the phase of the first clock signal and the phase of the second clock signal different.

4. The display apparatus of claim 3, wherein the first random phase modulation module and the second random phase modulation module randomly select a first candidate clock signal and a second candidate clock signal having different phases as the first clock signal and the second clock signal respectively from a plurality of candidate clock signals in a random phase selecting way.

5. The display apparatus of claim 3, wherein the first random phase modulation module and the second random phase modulation module randomly reset the phase of the first clock signal and the phase of the second clock signal respectively to generate the first clock signal and the second clock signal having different phases respectively.

6. The display apparatus of claim 1 further comprising:
a measuring module, coupled to the plurality of driving circuits, for measuring a total energy and an electromagnetic interference value of the plurality of clock signals generated by the plurality of driving circuits.

7. The display apparatus of claim 6, wherein the plurality of clock signals generated by the plurality of driving circuits has randomly distributed different phases respectively, the total energy of the plurality of clock signals measured by the measuring module at different times is approximately equal and the electromagnetic interference value of the plurality of clock signals measured by the measuring module at different times is lowest.

8. A driving circuit applied to a display apparatus and coupled to a display panel of the display apparatus, the driving circuit comprising:
a clock generation module, for receiving a first timing control signal and generating a plurality of first candidate clock signals having different phases;
a random phase selection module, coupled to the clock generation module, for randomly selecting different first candidate clock signals as a first clock signal at different times from the plurality of first candidate clock signals to randomly change a phase of the first clock signal with time; and
a source driving module, coupled between the random phase selection module and the display panel, for receiving the first clock signal and outputting a first source driving signal to the display panel.

9. The driving circuit of claim 8, wherein another driving circuit different from the driving circuit is also applied to the display apparatus and coupled to the display panel, the another driving circuit comprises:
another clock generation module, for receiving a second timing control signal and generating a plurality of second candidate clock signals having different phases;
another random phase selection module, coupled to the another clock generation module, for randomly selecting different second candidate clock signals as a second clock signal at different times from the plurality of second candidate clock signals to randomly change a phase of the second clock signal with time; and
another source driving module, coupled between the another random phase selection module and the display panel, for receiving the second clock signal and outputting a second source driving signal to the display panel.

10. The driving circuit of claim 9, wherein the display apparatus further comprises a measuring module, the measuring module is coupled to the driving circuit and the another driving circuit respectively and used for measuring a total energy and an electromagnetic interference value of the first clock signal of the driving circuit and the second clock signal of the another driving circuit.

11. The driving circuit of claim 10, wherein a phase of the first clock signal of the driving circuit is different from a phase of the second clock signal of the another driving circuit, the total energy of the first clock signal of the driving circuit and the second clock signal of the another driving circuit measured by the measuring module at different times is approximately equal and the electromagnetic interference value of the first clock signal of the driving circuit and the second clock signal of the another driving circuit measured by the measuring module at different times is lowest.

12. The driving circuit of claim 8, wherein the random phase selection module comprises:
a random phase selection unit, for generating a random phase selection signal; and
a multiplexing unit, coupled to the clock generation module, the random phase selection unit and the source driving module respectively, for receiving the plurality of first candidate clock signals from the clock generation module and the random phase selection signal from the random phase selection unit and randomly selecting different first candidate clock signals having different phases as the first clock signal at different times from the plurality of first candidate clock signals to randomly change the phase of the first clock signal with time.

13. The driving circuit of claim 9, wherein the another random phase selection module comprises:
another random phase selection unit, for generating another random phase selection signal; and
another multiplexing unit, coupled to the another clock generation module, the another random phase selection unit and the another source driving module respectively, for receiving the plurality of second candidate clock signals from the another clock generation module and the another random phase selection signal from the another random phase selection unit and randomly selecting different second candidate clock signals having different phases as the second clock signal at different times from the plurality of second candidate clock signals to randomly change the phase of the second clock signal with time.

14. A driving circuit applied to a display apparatus and coupled to a display panel of the display apparatus, the driving circuit comprising:
a clock generation module, for receiving a first timing control signal and generating a first clock signal;
a random phase resetting module, coupled to the clock generation module, for receiving the first clock signal and randomly resetting the first clock signal at different times to randomly change a phase of the first clock signal with time; and
a source driving module, coupled between the random phase resetting module and the display panel, for receiving the first clock signal and outputting a first source driving signal to the display panel.

15. The driving circuit of claim 14, wherein another driving circuit different from the driving circuit is also applied to the display apparatus and coupled to the display panel, the another driving circuit comprises:
another clock generation module, for receiving a second timing control signal and generating a second clock signal;
another random phase resetting module, coupled to the another clock generation module, for receiving the second clock signal and randomly resetting the second clock signal at different times to randomly change a phase of the second clock signal with time; and
another source driving module, coupled between the another random phase resetting module and the display panel, for receiving the second clock signal and outputting a second source driving signal to the display panel.

16. The driving circuit of claim 15, wherein the display apparatus further comprises a measuring module, coupled to the driving circuit and the another driving circuit, for measuring a total energy and an electromagnetic interference value of the first clock signal of the driving circuit and the second clock signal of the another driving circuit.

17. The driving circuit of claim 16, wherein a phase of the first clock signal of the driving circuit is different from a phase of the second clock signal of the another driving circuit, the total energy of the first clock signal of the driving circuit and the second clock signal of the another driving circuit measured by the measuring module at different times is approximately equal and the electromagnetic interference value of the first clock signal of the driving circuit and the second clock signal of the another driving circuit measured by the measuring module at different times is lowest.

18. The driving circuit of claim 14, wherein the random phase resetting module comprises:
a random phase resetting unit, for generating a random phase resetting signal; and
a phase determining unit, coupled to the clock generation module, the random phase resetting unit and the source driving module, for receiving the first clock signal from the clock generation module and the random phase resetting signal from the random phase resetting unit and randomly resetting the first clock signal at different times according to the random phase resetting signal to randomly change the phase of the first clock signal with time.

19. The driving circuit of claim 15, wherein the another random phase resetting module comprises:
another random phase resetting unit, for generating another random phase resetting signal; and
another phase determining unit, coupled to the another clock generation module, the another random phase resetting unit and the another source driving module, for receiving the second clock signal from the another clock generation module and the another random phase resetting signal from the another random phase resetting unit and randomly resetting the second clock signal at different times according to the another random phase resetting signal to randomly change the phase of the second clock signal with time.
